(19) United States
(12) Patent Application Publication
(10) Pub. No.: US 2026/0236679 A1
(43) Pub. Date: Aug. 13, 2026

(54) DATA MANAGEMENT COPROCESSOR FOR THE SPECULATIVE INFERENCE OF A LARGE LANGUAGE MODEL

(71) Applicant: Microsoft Technology Licensing, LLC, Redmond, WA (US)

(72) Inventors: Zhuo RUAN, San Jose, CA (US); Edward GAMSARAGAN, Kirkland, WA (US); Arijit CHATTOPADHYAY, Seattle, WA (US)

(21) Appl. No.: 19/047,985

(22) Filed: Feb. 7, 2025

(51) Int. Cl. G06F 40/284; G06F 12/1081

(52) U.S. Cl. CPC G06F 40/284; G06F 12/1081

(57) ABSTRACT

A data management coprocessor, and a method in a data management coprocessor, for interoperating with an artificial intelligence (Al) accelerator and a central processing unit (CPU) in a computer system. The method includes allocating a cache buffer in a memory distinct from the coprocessor. The method also includes predicting a subset of large language model (LLM) weights necessary for generating a subsequent token by an LLM executing in the Al accelerator. The method also includes initiating the caching of these predicted LLM weights into the cache buffer, e.g., before the LLM generates the next token. The data management processor may also roll back a state of the LLM executing in the Al accelerator when a confidence score for the next token meets a criterion indicating a misprediction.

### BACKGROUND

Large language models (LLMs) have emerged as transformative tools in artificial intelligence, driving advances in natural language processing tasks such as text generation, summarization, translation, question-answering, image generation, and video generation. These models, built using deep learning architectures like transformers, consist of massive numbers of parameters, often ranging from billions to trillions. Parameters represent learned weights and biases that enable the model to process and predict text sequences. As model sizes increase to achieve higher accuracy and more complex reasoning capabilities, the storage and access requirements for these parameters grow proportionally, introducing significant demands on memory systems during inference.

Inference in LLMs involves generating output tokens, such as words or sub-words, based on input tokens provided by the user. This process loads the model's parameters into memory and repeatedly accesses them across multiple computational steps. In addition to parameter storage, inference generates a large volume of intermediate data, commonly referred to as activations, which represent the internal states of the model during computation. These activations are often retained for subsequent processing or reused across layers of the model. Both the sheer size of the parameters and the growing complexity of activations contribute to substantial memory requirements, both in terms of capacity (the total amount of data that must be stored) and bandwidth (the rate at which data must be accessed and transferred).

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to a method implemented in a data management coprocessor that interoperates with an artificial intelligence (AI) accelerator and a central processing unit (CPU) in a computer system, including: allocating a cache buffer in a memory separate from the data management coprocessor; predicting a subset of large language model (LLM) weights, the subset LLM weights for the use of generating a next token by an LLM executing in the AI accelerator; and initiating caching of the subset of LLM weights into the cache buffer.

In some aspects, the techniques described herein relate to a data management coprocessor including: a cache manager that allocates a cache buffer in a memory separate from the data management coprocessor; an LLM weight predictor that predicts a subset of LLM weights, the subset LLM weights for the use of generating a next token by an LLM executing in an AI accelerator; a direct memory access (DMA) initiator that initiates caching of the subset of LLM weights into the cache buffer; and a misprediction manager that rolls back a state of the LLM executing in the AI accelerator when a confidence score for the next token meets a criterion indicating a misprediction.

In some aspects, the techniques described herein relate to a computer system, including: a processor system; an AI accelerator; and a data management coprocessor that: allocates a cache buffer in a memory separate from the data management coprocessor; predicts a subset of LLM weights, the subset LLM weights for the use of generating a next token by an LLM executing in the AI accelerator; initiates caching of the subset of LLM weights into the cache buffer; and rolls back a state of the LLM executing in the AI accelerator when a confidence score for the next token meets a criterion indicating a misprediction.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that utilizes a data management coprocessor for the speculative inference of a large language model (LLM) at an artificial intelligence (AI) accelerator;

FIG. 2 illustrates an example of a data management coprocessor for the speculative inference of an LLM at an AI accelerator;

FIGS. 3A and 3B illustrate an example of speculative data management by a data management coprocessor; and

FIG. 4 illustrates a flow chart of an example of a method of data management by a coprocessor for speculative inference of an LLM at an AI accelerator.

### DETAILED DESCRIPTION

As large language models (LLMs) scale to, e.g., trillions of parameters, the memory required to store weights alone can exceed the capacities of contemporary computer systems. This is particularly true of consumer computer systems, such as laptop computers, desktop computers, tablets, and smartphones. Simultaneously, activations-generated during forward passes through the LLM neural network-can occupy additional gigabytes of memory, especially when handling long input sequences or generating long outputs. Beyond capacity concerns, the memory bandwidth required to move these large data sets into and out of compute units can quickly become a limiting factor. For example, the iterative nature of token generation in LLMs means that memory access must be frequent and highly efficient for reasonable LLM operation, placing further strain on existing memory hierarchies. The combination of vast model parameters and large intermediate activations presents a significant challenge to running LLM inference, particularly on consumer computer systems where memory barriers (e.g., capacity, bandwidth) quickly limit the size of LLMs that can be operated. Attempts to overcome memory barriers focus on reducing the size or complexity of the LLM itself to reduce the required memory footprint and bandwidth during inference, e.g., through quantization, non-zero compression, and/or sparsity encoding. However, these techniques adversely impact the performance and accuracy of the LLM.

At least some embodiments described herein overcome these memory barriers by introducing a data management coprocessor that interoperates with an artificial intelligence (AI) accelerator, such as a machine learning accelerator (MLA), a neural processing unit (NPU), a tensor processing unit (TPU), or a graphics processing unit (GPU). The data management coprocessor handles LLM data management by dynamically loading or prefetching into memory a subset of weights and activations needed for a current LLM inference task being executed by the AI accelerator. This data management coprocessor enables the speculative execution of LLMs under current memory constraints, even as LLM size continuously scales, by streaming a subset of LLM's weights and activations into memory as needed, which avoids storing the entirety of the LLM's weights and activations in memory at once.

Thus, the data management coprocessor provides the technical advantage of using hardware to support prediction, where only portions of an LLM are dynamically loaded into memory just in time for use by an AI accelerator. This significantly reduces the requirements of memory bandwidth and capacity, so LLMs can scale and be stored in lower-cost, lower-bandwidth, higher-capacity storage solutions, such as solid-state drives (SSDs), rather than entirely residing in dynamic random-access memory (DRAM) memory during inference. While a data management coprocessor can operate in concert with other techniques for reducing the size or complexity of the LLM itself (e.g., quantization, non-zero compression, sparsity encoding), the data management coprocessor can also operate independently of these techniques and avoid the adverse impacts these techniques have on the performance and accuracy of LLMs. Thus, the data management coprocessor enables full-fidelity LLM inference on hardware with limited memory resources, such as consumer computer systems.

A data management coprocessor can perform a variety of responsibilities. In embodiments, the data management coprocessor allocates cache buffers, e.g., in AI accelerator local memory and/or system memory (e.g., DRAM). In embodiments, the data management coprocessor also utilizes windowed historical internal LLM states and activations (e.g., for the last n tokens generated, such as 128 tokens, 500 tokens, or 1000 tokens) to predict what subset of LLM weights to prefetch into memory for the next round of inference by the AI accelerator. In one example, the data management coprocessor makes this prediction primarily through vector operations, such as low-rank predictors. Based on these prediction results, the data management coprocessor creates cache management commands and/or direct memory access (DMA) descriptors, for transferring the predicted portion of weights into the cache buffers via DMA. In some embodiments, the data management coprocessor also determines a confidence score for a token generated by the AI accelerator (e.g., indicating if the token was correctly predicted or mispredicted). If the confidence score meets a criterion indicating a misprediction (e.g., confidence score below a threshold number), the data management coprocessor rolls back LLM execution at the AI accelerator so the AI accelerator can re-generate the token using a different subset of weights and internal states.

The data management coprocessor disclosed herein can be utilized in various scenarios. In one scenario, a data management coprocessor partially and dynamically prefetches LLM weights into memory. In this scenario, the data management coprocessor predicts what LLM neurons are active (e.g., producing non-zero activations) and only loads the weights of those neurons into the allocated cache buffers. Here, the data management coprocessor can make low-rank predictions for weight prefetching, doing so in parallel with the regular inference by an AI accelerator. In some implementations, the data management coprocessor checks for token mispredictions.

In embodiments, a data management coprocessor has one or more of a vector pipeline, a scalar pipeline, and a DMA interface. In embodiments, the vector pipeline offers vector computing capability of making predictions of weights/activations for prefetching (e.g., using vector operations, such as low-rank predictors). In embodiments, the scalar pipeline generates data management commands/descriptors (e.g., management commands, DMA descriptors) and coordinates data transfer and caching buffer replacement via communications with an AI accelerator and/or system-level central processing unit (CPU). In embodiments, the data management coprocessor is connected to an AI accelerator fabric and has read/write access to the AI accelerator's local shared memory and system memory (e.g., including DRAM and system-level cache).

In another scenario, the data management coprocessor operates with an LLM that includes a mixture of experts (MoE). When an LLM includes an MoE, different “experts” (e.g., defined subsets of the LLM) become active to generate different tokens based on those expert's specialties. In embodiments, when used with an LLM that includes an MoE, the data management coprocessor predicts what experts will be used and speculatively loads them into the allocated cache buffers.

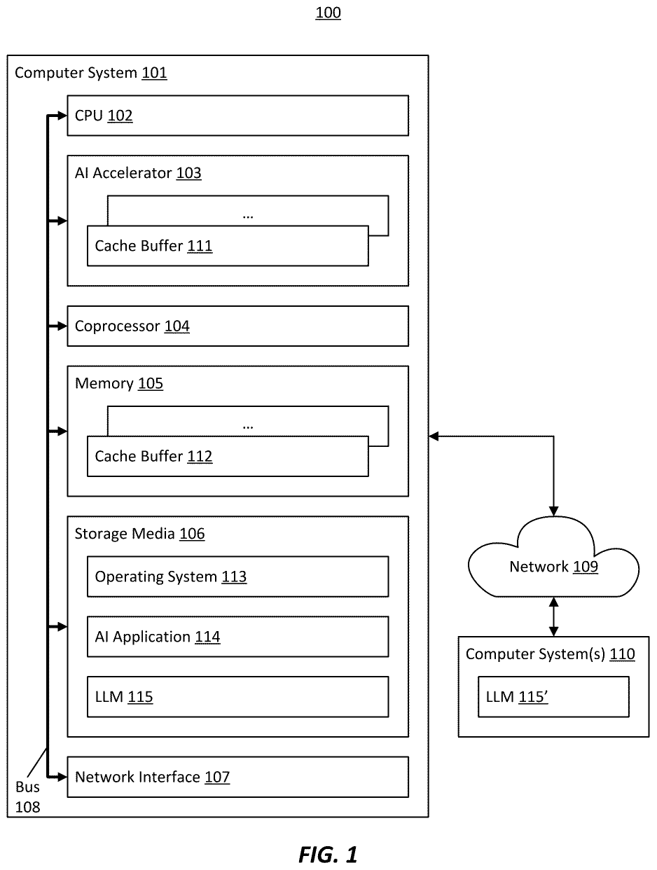

FIG. 1 illustrates an example 100 of a computer architecture that utilizes a data management coprocessor for the speculative inference of an LLM at an AI accelerator. As shown, the computer architecture includes a computer system 101 comprising a CPU 102 (e.g., a single processor or a plurality of processors), an AI accelerator 103 (e.g., MLA, NPU, TPU, GPU), a data management coprocessor (coprocessor 104), a memory 105 (e.g., system or main memory), a storage medium 106 (e.g., a single computer-readable storage medium, or a plurality of computer-readable storage media), and a network interface 107 all interconnected by a bus 108. Using network interface 107, computer system 101 may interconnect via a network 109 (e.g., a local-area network and/or a wide-area network, such as the Internet) to computer system 110 (e.g., a single computer system or a plurality of computer systems).

In FIG. 1, the AI accelerator 103 is illustrated separately from CPU 102. However, in some implementations, the AI accelerator 103 and CPU 102 are combined (e.g., on the same silicon die). Additionally, while CPU 102, AI accelerator 103, and coprocessor 104 are functionally distinct, in embodiments, they may be variously combined in the same package, such as a System on Chip (SoC) or a System on a Package (SoP).

FIG. 1 illustrates the storage medium 106 as storing computer-executable instructions implementing an operating system 113 and an AI application 114. While AI application 114 is illustrated as being distinct from operating system 113 (e.g., a user-installed application), in some embodiments, AI application 114 may be part of operating system 113 (e.g., as a system service or bundled application). Regardless of the form of AI application 114, AI application 114 utilizes AI accelerator 103 to conduct inference tasks with an LLM 115 stored on storage medium 106. LLM 115 may be an LLM created (e.g., trained) in computer system 101. Alternatively, LLM 115 may be all or part of an LLM obtained from a remote computer system (e.g., LLM 115′ at computer system 110).

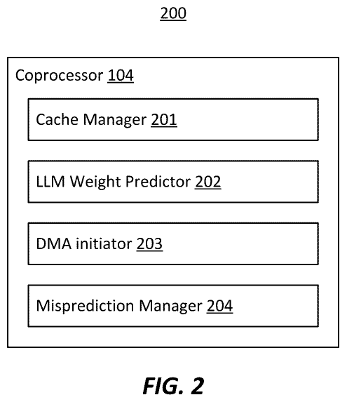

FIG. 2 illustrates an example 200 of the coprocessor 104 of FIG. 1. Each component of coprocessor 104 depicted in FIG. 2 represents various functionalities that coprocessor 104 may implement under the embodiments described herein. These components-including their identity and arrangement-are presented merely as an aid in describing example embodiments of coprocessor 104. Notably, the functionality of these components can be implemented in various manners, both hardware and software. For example, the functionality may be implemented via digital hardware logic (e.g., an arrangement of transistors, a field-programmable gate array (FPGA)), and/or computer-executable instructions executed at a processing unit within coprocessor 104.

In embodiments, the cache manager 201 manages the allocation, deallocation, resizing, etc., of cache buffers for storing a portion of model weights for use by AI accelerator 103 during inferencing with LLM 115. In embodiments, the cache manager 201 manages cache buffers within system memory, shown in FIG. 1 as cache buffer 112 (e.g., one or more cache buffers). In additional or alternative embodiments, the cache manager 201 manages cache buffers within a local memory of AI accelerator 103, shown in FIG. 1 as cache buffer 111 (e.g., one or more cache buffers). In general, the cache manager 201 can manage cache buffers within any available memory, such as a cache within CPU 102 and/or a cache associated with storage medium 106.

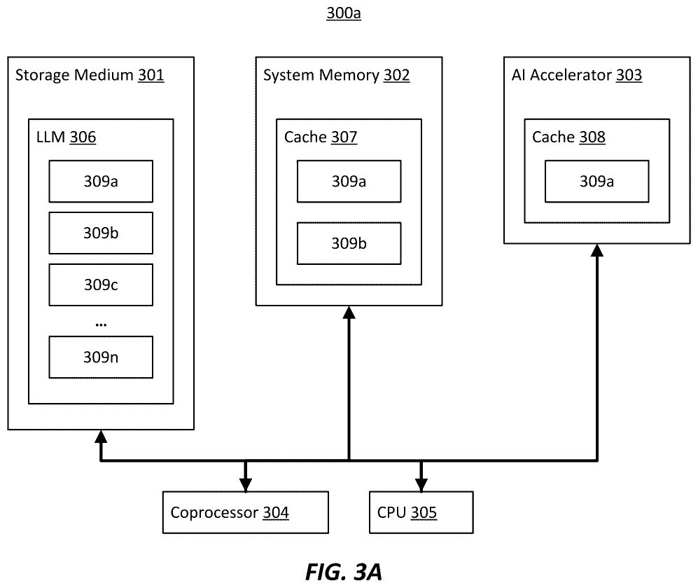

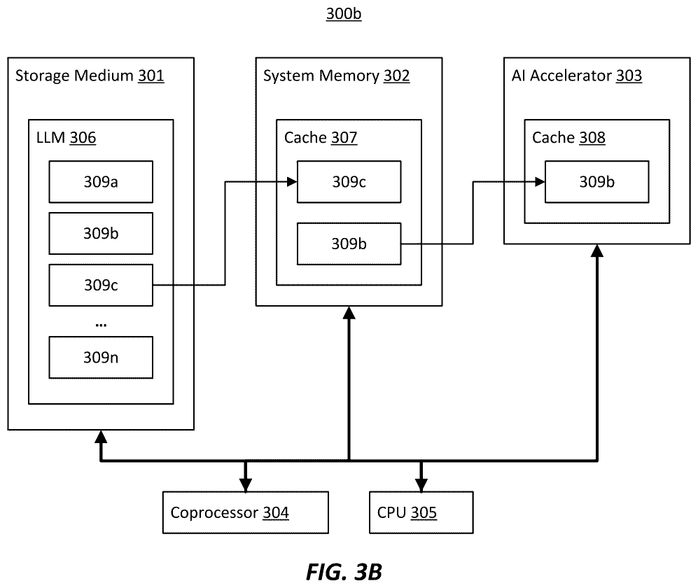

In embodiments, the cache manager 201 manages a hierarchy of caches, as well as the movement of LLM data among those caches. For example, the cache manager 201 may manage the movement of LLM weights among storage medium 106, memory 105, and AI accelerator 103. These embodiments will be described in additional detail in connection with FIGS. 3A-3B.

In embodiments, the LLM weight predictor 202 utilizes historical internal LLM states (e.g., internal LLM context from generating a token) and activations (e.g., previously generated outputs of each LLM layer from generating a token) to predict a subset weights of LLM 115 to prefetch into one or more caches allocated by the cache manager 201 for use in the next round of inference by the AI accelerator 103. Stated differently, based on the current state of LLM 115 at AI accelerator 103, the LLM weight predictor 202 determines a subset of weights of LLM 115 to provide the AI accelerator 103 for generating the next token.

In some embodiments, to reduce memory and computation requirements, the LLM weight predictor 202 uses a “windowed” approach, in which it considers only the internal LLM states and activations corresponding to a window of the last n tokens generated by the AI accelerator 103, where n is a positive integer, such as 128 tokens, 500 tokens, or 1000 tokens. Any value of n that can be utilized at computer system 101 can be used. In embodiments, the LLM weight predictor 202 performs computations, such as matrix multiplication and vector operations, to predict what weights to pull in for the next token to be generated. In one example, the LLM weight predictor 202 utilizes a low-rank predictor that uses smaller matrices (low-rank approximations) rather than a full-weight matrix to dynamically determine the most relevant subset of weights needed for the next token prediction. However, various prediction techniques could be utilized.

In embodiments, the DMA initiator 203 initiates the movement of LLM weights data among the caches allocated by the cache manager 201 to pull the weights predicted by the LLM weight predictor 202 into appropriate caches. In embodiments, the DMA initiator 203 creates cache management commands (e.g., defining a cache buffer replacement operation such as first-in-first-out (FIFO) or least-recently-used (LRU)) and/or DMA descriptors (e.g., source memory address, destination memory address, data transfer size) to initiate the transfer the predicted portion of weights into the cache buffers via DMA.

In embodiments, the misprediction manager 204 determines a confidence score for a token generated by the AI accelerator 103. In some examples, the misprediction manager 204 utilizes a ‘softmax’ calculation that converts raw scores into normalized probabilities. However, various techniques for calculating a confidence score could be used. In embodiments, this confidence score indicates if the token was correctly predicted or mispredicted. For example, the misprediction manager 204 may determine that a token was correctly predicted if a confidence score for the token is above a determined threshold (e.g., 0.7, 0.75, 0.8); if not, the misprediction manager 204 may determine that the token was mispredicted. In embodiments, if the misprediction manager 204 determines that the token was mispredicted, it “rolls back” LLM state at AI accelerator 103 so that the AI accelerator 103 can re-generate the token using a different subset of weights. For example, the misprediction manager 204 rolls back the LLM state at AI accelerator 103 based on sending an instruction to AI accelerator 103, replacing internal context LLM within the local memory of AI accelerator 103, etc.

FIGS. 3A and 3B illustrate an example of speculative data management by a data management coprocessor, such as AI accelerator 103. Initially, FIG. 3A illustrates an example 300a including a storage medium 301 (e.g., storage medium 106), a system memory 302 including a cache buffer 307 (e.g., memory 105 and cache buffer 112), an AI accelerator 303 including a cache buffer 308 (e.g., AI accelerator 103 and cache buffer 111), a coprocessor 304 (e.g., coprocessor 104), and a CPU 305 (e.g., CPU 102), all interconnected by a bus (represented by arrows connecting these elements).

Storage medium 301 stores an LLM 306, such as LLM 115, including all the weights associated with LLM 306 (shown as weights portion 309a, weights portion 309b, weights portion 309c, etc., to weights portion 309n). In general, an LLM can include any number of weights, which can be divisible in many ways (e.g., based on neuron associations, based on MoE, based on internal LLM layers).

In example 300a, cache manager 201 has previously allocated cache buffer 307 in system memory 302 and has allocated cache buffer 308 in AI accelerator 303. In embodiments, this forms a cache hierarchy in which LLM weights are moved from storage medium 301 to cache buffer 307 (e.g., because those weights are predicted by LLM weight predictor 202 to be needed for near-future token generation) and from cache buffer 307 to cache buffer 308 (e.g., because those weights are predicted by LLM weight predictor 202 to be needed for the generation of the next token). Notably, LLM 306, cache buffer 307, and cache buffer 308 have visually different sizes, indicating that, in many examples, LLM 306 is larger than cache buffer 307 (and thus would not entirely fit in cache buffer 307), and cache buffer 307 is larger than cache buffer 308 (and thus cache buffer 307 can store more LLM weights than cache buffer 308). In example 300a, based on LLM weight predictor 202 and DMA initiator 203, and prior token generation by AI accelerator 303, cache buffer 307 stores weights portion 309a and weights portion 309b, and cache buffer 308 stores weights portion 309a.

FIG. 3B illustrates an example 300b after a round of operation of LLM weight predictor 202 and DMA initiator 203. In particular, in example 300b, coprocessor 104 has replaced weights portion 309a with weights portion 309c in cache buffer 307, and coprocessor 104 has replaced weights portion 309a with weights portion 309b in cache buffer 308. For example, LLM weight predictor 202 has predicted that weights portion 309b will be needed by AI accelerator 303 to generate the next token and that weights portion 309c may be needed by accelerator 303 in the near term (e.g., for the token following the next token).

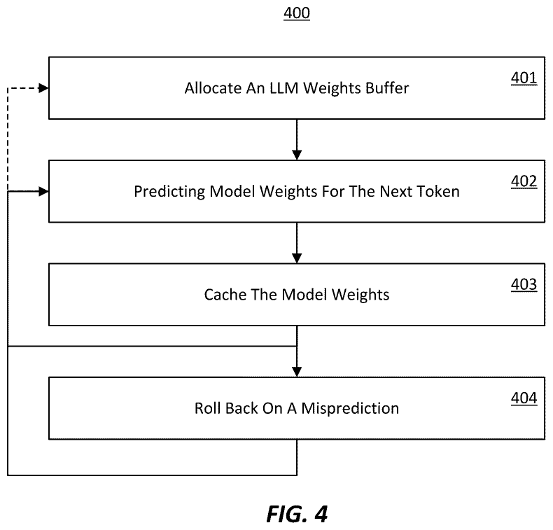

Embodiments of coprocessor 104 are now described in connection with FIG. 4, which illustrates a flow chart of an example method 400 of data management by a coprocessor for speculative inference of an LLM at an AI accelerator. In embodiments, method 400 is implemented by a data management coprocessor, such as coprocessor 104. Logic for implementing method 400 may be implemented via digital hardware logic (e.g., an arrangement of transistors, an FPGA) and/or computer-executable instructions executed at a processing unit within coprocessor 104.

The following discussion now refers to a method and method acts. Although the method acts are discussed in specific orders or are illustrated in a flow chart as occurring in a particular order, no order is required unless expressly stated or required because an act is dependent on another act being completed before the act is performed.

Referring to FIG. 4, in embodiments, method 400 comprises act 401 of allocating an LLM weights buffer. In some embodiments, act 401 comprises allocating a cache buffer in a memory separate from the data management coprocessor. For example, the cache manager 201 allocates cache buffer 111 within the local memory of AI accelerator 103 and/or allocates cache buffer 112 within memory 105.

Method 400 also comprises act 402 of predicting model weights for the next token. In some embodiments, act 402 comprises predicting a subset of LLM weights, the subset LLM weights for the use of generating a next token by an LLM executing in the AI accelerator. For example, LLM weight predictor 202 utilizes historical internal LLM states (e.g., internal LLM context at AI accelerator 103 from generating prior token(s)) and activations (e.g., previously generated outputs of each LLM layer from generating a token) to predict a portion of weights of LLM 115 to prefetch into caches allocated by the cache manager 201 in act 401, for use in the next round of inference by the AI accelerator 103. In example 300b, for instance, LLM weight predictor 202 predicts that AI accelerator 103 will need weights portion 309b.

In embodiments, LLM weight predictor 202 uses a windowed approach, in which it considers only the internal LLM states and activations for a window of the last n tokens generated by the AI accelerator 103, where n is a positive integer (e.g., 128, 500, or 1000). Thus, in some embodiments of act 402, predicting the subset of LLM weights comprises identifying a window of historical internal states and activations of the LLM executing in the AI accelerator.

LLM weight predictor 202 can use various techniques to make predictions from internal LLM state/activations. For example, the LLM weight predictor 202 may perform matrix multiplication and/or vector operations. In one example, the LLM weight predictor 202 utilizes a low-rank predictor that uses smaller matrices (low-rank approximations) rather than a full-weight matrix to dynamically determine the most relevant subset of weights needed for the next token prediction. Thus, in some embodiments of act 402, predicting the subset of LLM weights also comprises inputting the window of historical internal states and activations into a dynamic weight selection technique, such as a low-rank predictor, to obtain the subset of LLM weights.

Method 400 also comprises act 403 of caching the model weights. In some embodiments, act 403 comprises initiating caching of the subset of LLM weights into the cache buffer. In embodiments, this caching is done before the generation of the next token by the LLM executing in the AI accelerator (e.g., prior to the LLM using that weight in the generation of the next token). For example, the DMA initiator 203 initiates the data movement among the caches allocated by the cache manager 201 to pull the weights predicted by the LLM weight predictor 202 into appropriate caches. In example 300b, for instance, the DMA initiator 203 initiates the movement of weights portion 309b into cache buffer 308.

In some examples, the DMA initiator 203 creates a cache management command, for example, defining a cache buffer replacement operation such as FIFO or LRU. Thus, in some embodiments of act 403, initiating caching of the subset of LLM weights into the cache buffer includes generating a cache management command defining a cache buffer replacement operation. In other examples, the DMA initiator 203 creates a DMA descriptor, for example, including a source memory address, a destination memory address, and a data transfer size. Thus, in some embodiments of act 403, initiating caching of the subset of LLM weights into the cache buffer includes generating a DMA descriptor comprising one or more of a source memory address, a destination memory address, or a data transfer size. In some embodiments, initiating caching of the subset of LLM weights into the cache buffer also includes sending the cache management command or the DMA descriptor to at least one of AI accelerator 103 or CPU 102.

In some situations, method 400 may also comprise act 404 of rolling back on a misprediction. In some embodiments, act 404 comprises rolling back a state of the LLM executing in the AI accelerator when a confidence score for the next token meets the criterion indicating a misprediction. For example, the misprediction manager 204 determines a confidence score for a token generated by the AI accelerator 103, the confidence score indicating if the token was correctly predicted or mispredicted by the AI accelerator 103. If the confidence score indicates that the token is mispredicted (e.g., the confidence score is below a determined threshold, such as 0.7), the misprediction manager 204 determines that the token was mispredicted. In this case, the misprediction manager 204 rolls back LLM state at AI accelerator 103 (e.g., based on sending an instruction to AI accelerator 103 or based on replacing internal context LLM within the local memory of AI accelerator 103). In some examples, the confidence score is calculated based on a softmax function.

In general, coprocessor 104 operates parallel with inference by AI accelerator 103, ensuring that the AI accelerator 103 has the LLM weights predicted to be needed by AI accelerator 103 for the next round of token generation. Thus, at least a portion of method 400 continuously repeats, as indicated by arrows in FIG. 4. For example, an arrow extending from act 403 to act 402 indicates that if a token was correctly predicted or if the AI accelerator 103 does not perform token misprediction, then method 400 loops from act 403 to act 402 for each token generated by the AI accelerator 103. An arrow extending from act 404 to act 402 indicates that if a token was mispredicted then method 400 loops from act 404 to act 402 after rolling back the LLM state and waiting for the AI accelerator 103 to re-generate the token. Notably, method 400 may include more than one instance of act 404 for a given token, e.g., if the token is repeatedly mispredicted. A further broken arrow extending to act 401 indicates that cache manager 201 can adjust cache allocations as needed (e.g., based on the size of an input prompt).

Thus, disclosed herein are a data management coprocessor, and a method in a data management coprocessor, for interoperating with an AI accelerator and a CPU in a computer system. The method includes allocating a cache buffer in a memory distinct from the coprocessor. The method also includes predicting a subset of LLM weights necessary for generating a subsequent token by an LLM executing in the AI accelerator. The method also includes initiating the caching of these predicted LLM weights into the cache buffer before the LLM generates the next token. The data management processor may also roll back a state of the LLM executing in the AI accelerator when a confidence score for the next token meets a criterion indicating a misprediction.

Alternatively or in addition to the other examples described herein, examples include any combination of the following:
Clause 1. A method implemented in a data management coprocessor that interoperates with an artificial intelligence (AI) accelerator and a central processing unit (CPU) in a computer system, comprising: allocating a cache buffer in a memory separate from the data management coprocessor; predicting a subset of large language model (LLM) weights, the subset LLM weights for the use of generating a next token by an LLM executing in the AI accelerator; and initiating caching of the subset of LLM weights into the cache buffer before the generation of the next token by the LLM executing in the AI accelerator.
Clause 2. The method of clause 1, wherein the memory separate from the data management coprocessor is at least one of, a local memory in the AI accelerator, or a system memory of the computer system.
Clause 3. The method of any of clause 1 or claim 2, wherein predicting the subset of LLM weights comprises: identifying a window of historical internal states and activations of the LLM executing in the AI accelerator; and inputting the window of historical internal states and activations into a dynamic weight selection technique to obtain the subset of LLM weights.
Clause 4. The method of clause 3, wherein the dynamic weight selection technique is a low-rank predictor.
Clause 5. The method of any of clause 1 to claim 4, wherein initiating caching of the subset of LLM weights into the cache buffer includes generating at least one of, a cache management command defining a cache buffer replacement operation, or a DMA descriptor comprising one or more of a source memory address, a destination memory address, or a data transfer size.
Clause 6. The method of clause 5, wherein initiating caching of the subset of LLM weights into the cache buffer also includes sending the cache management command or the DMA descriptor to at least one of, the AI accelerator, or the CPU.
Clause 7. The method of any of clause 1 to claim 6, wherein the method further comprises: after generation of the next token by the LLM executing in the AI accelerator, determining if a confidence score for the next token meets a criterion indicating a misprediction; and when the confidence score for the next token meets the criterion indicating a misprediction, rolling back a state of the LLM executing in the AI accelerator.
Clause 8. The method of clause 7, wherein the confidence score is calculated based on a softmax function.
Clause 9. A data management coprocessor comprising: a cache manager that allocates a cache buffer in a memory separate from the data management coprocessor; a large language model (LLM) weight predictor that predicts a subset of LLM weights, the subset LLM weights for the use of generating a next token by an LLM executing in an AI accelerator; a direct memory access (DMA) initiator that initiates caching of the subset of LLM weights into the cache buffer before the generation of the next token by the LLM executing in the AI accelerator; and a misprediction manager that rolls back a state of the LLM executing in the AI accelerator when a confidence score for the next token meets a criterion indicating a misprediction.
Clause 10. The data management coprocessor of clause 9, wherein the LLM weight predictor predicts the subset of LLM weights by, identifying a window of historical internal states and activations of the LLM executing in the AI accelerator; and inputting the window of historical internal states and activations into a dynamic weight selection technique to obtain the subset of LLM weights.
Clause 11. The data management coprocessor of clause 10, wherein the dynamic weight selection technique is a low-rank predictor.
Clause 12. The data management coprocessor of any of clause 9 to claim 11, wherein the DMA initiator initiates caching of the subset of LLM weights into the cache buffer by generating at least one of, a cache management command defining a cache buffer replacement operation, or a DMA descriptor comprising one or more of a source memory address, a destination memory address, or a data transfer size.
Clause 13. The data management coprocessor of clause 12, wherein the DMA initiator initiates caching of the subset of LLM weights into the cache buffer by sending the cache management command or the DMA descriptor to at least one of, the AI accelerator, or a central processing unit (CPU).
Clause 14. The data management coprocessor of any of clause 9 to claim 13, wherein the misprediction manager calculates the confidence score based on a softmax function.
Clause 15. A computer system, comprising: a processor system; an artificial intelligence (AI) accelerator; and a data management coprocessor that: allocates a cache buffer in a memory separate from the data management coprocessor; predicts a subset of large language model (LLM) weights, the subset LLM weights for the use of generating a next token by an LLM executing in the AI accelerator; initiates caching of the subset of LLM weights into the cache buffer before the generation of the next token by the LLM executing in the AI accelerator; and rolls back a state of the LLM executing in the AI accelerator when a confidence score for the next token meets a criterion indicating a misprediction.
Clause 16. The computer system of clause 15, wherein the memory separate from the data management coprocessor is at least one of, a local memory in the AI accelerator, or a system memory of the computer system.
Clause 17. The computer system of any of clause 15 or claim 16, wherein predicting the subset of LLM weights comprises: identifying a window of historical internal states and activations of the LLM executing in the AI accelerator; and inputting the window of historical internal states and activations into a dynamic weight selection technique to obtain the subset of LLM weights.
Clause 18. The computer system of clause 17, wherein the dynamic weight selection technique is a low-rank predictor.
Clause 19. The computer system of any of clause 15 to claim 18, wherein initiating caching of the subset of LLM weights into the cache buffer includes: generating at least one of a cache management command defining a cache buffer replacement operation or a DMA descriptor comprising one or more of a source memory address, a destination memory address, or a data transfer size; and sending the cache management command or the DMA descriptor to the AI accelerator or the processor system.
Clause 20. The computer system of any of clause 15 to claim 19, wherein the confidence score is calculated based on a softmax function.

Embodiments of the disclosure comprise or utilize a special-purpose or general-purpose computer system that includes computer hardware, such as, for example, a processor system and system memory, as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), SSDs, flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which, when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more CPUs, one or more GPUs, one or more NPUs, and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (Saas), Platform as a Service (PaaS), Infrastructure as a Service (laaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system (OS) and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a data management coprocessor that interoperates with an artificial intelligence (AI) accelerator and a central processing unit (CPU) in a computer system, comprising:
allocating a cache buffer in a memory separate from the data management coprocessor;
predicting a subset of large language model (LLM) weights, the subset LLM weights for the use of generating a next token by an LLM executing in the AI accelerator; and
initiating caching of the subset of LLM weights into the cache buffer.

2. The method of claim 1, wherein the memory separate from the data management coprocessor is at least one of,
a local memory in the AI accelerator, or
a system memory of the computer system.

3. The method of claim 1, wherein predicting the subset of LLM weights comprises:
identifying a window of historical internal states and activations of the LLM executing in the AI accelerator; and
inputting the window of historical internal states and activations into a dynamic weight selection technique to obtain the subset of LLM weights.

4. The method of claim 3, wherein the dynamic weight selection technique is a low-rank predictor.

5. The method of a claim 1, wherein initiating caching of the subset of LLM weights into the cache buffer includes generating at least one of:
a cache management command defining a cache buffer replacement operation, or
a DMA descriptor comprising one or more of a source memory address, a destination memory address, or a data transfer size.

6. The method of claim 5, wherein initiating caching of the subset of LLM weights into the cache buffer also includes sending the cache management command or the DMA descriptor to at least one of:
the AI accelerator, or
the CPU.

7. The method of claim 1, wherein the method further comprises:
after generation of the next token by the LLM executing in the AI accelerator, determining if a confidence score for the next token meets a criterion indicating a misprediction; and
when the confidence score for the next token meets the criterion indicating a misprediction, rolling back a state of the LLM executing in the AI accelerator.

8. The method of claim 7, wherein the confidence score is calculated based on a softmax function.

9. A data management coprocessor comprising:
a cache manager that allocates a cache buffer in a memory separate from the data management coprocessor;
a large language model (LLM) weight predictor that predicts a subset of LLM weights, the subset LLM weights for the use of generating a next token by an LLM executing in an AI accelerator;
a direct memory access (DMA) initiator that initiates caching of the subset of LLM weights into the cache buffer; and
a misprediction manager that rolls back a state of the LLM executing in the AI accelerator when a confidence score for the next token meets a criterion indicating a misprediction.

10. The data management coprocessor of claim 9, wherein the LLM weight predictor predicts the subset of LLM weights by,
identifying a window of historical internal states and activations of the LLM executing in the AI accelerator; and
inputting the window of historical internal states and activations into a dynamic weight selection technique to obtain the subset of LLM weights.

11. The data management coprocessor of claim 10, wherein the dynamic weight selection technique is a low-rank predictor.

12. The data management coprocessor of claim 9, wherein the DMA initiator initiates caching of the subset of LLM weights into the cache buffer by generating at least one of:
a cache management command defining a cache buffer replacement operation, or
a DMA descriptor comprising one or more of a source memory address, a destination memory address, or a data transfer size.

13. The data management coprocessor of claim 12, wherein the DMA initiator initiates caching of the subset of LLM weights into the cache buffer by sending the cache management command or the DMA descriptor to at least one of:
the AI accelerator, or
a central processing unit (CPU).

14. The data management coprocessor of claim 9, wherein the misprediction manager calculates the confidence score based on a softmax function.

15. A computer system, comprising:
a processor system;
an artificial intelligence (AI) accelerator; and
a data management coprocessor that:
allocates a cache buffer in a memory separate from the data management coprocessor;
predicts a subset of large language model (LLM) weights, the subset LLM weights for the use of generating a next token by an LLM executing in the AI accelerator;
initiates caching of the subset of LLM weights into the cache buffer; and
rolls back a state of the LLM executing in the AI accelerator when a confidence score for the next token meets a criterion indicating a misprediction.

16. The computer system of claim 15, wherein the memory separate from the data management coprocessor is at least one of:
a local memory in the AI accelerator, or
a system memory of the computer system.

17. The computer system of claim 15, wherein predicting the subset of LLM weights comprises:
identifying a window of historical internal states and activations of the LLM executing in the AI accelerator; and
inputting the window of historical internal states and activations into a dynamic weight selection technique to obtain the subset of LLM weights.

18. The computer system of claim 17, wherein the dynamic weight selection technique is a low-rank predictor.

19. The computer system of claim 15, wherein initiating caching of the subset of LLM weights into the cache buffer includes:
generating at least one of a cache management command defining a cache buffer replacement operation or a DMA descriptor comprising one or more of a source memory address, a destination memory address, or a data transfer size; and
sending the cache management command or the DMA descriptor to the AI accelerator or the processor system.

20. The computer system of claim 15, wherein the confidence score is calculated based on a softmax function.
